(19) United States
(12) Patent Application Publication
(10) Pub. No.: US 2011/0122937 A1
(43) Pub. Date: May 26, 2011

(54) METHOD AND DEVICE FOR SNR MEASUREMENT AND COMMUNICATION SYSTEM COMPRISING SUCH DEVICE

(75) Inventors: Martin Kuipers, Dallgow-Doeberitz (DE); Matthias Schnitter, Muenchen (DE)

(73) Assignee: Nokia Siemens Networks Oy, Espoo (FI)

(21) Appl. No.: 12/936,232

(22) PCT Filed: Apr. 2, 2009
(86) PCT No.: PCT/EP2009/053915

§ 371 Date: Dec. 17, 2010

(30) Foreign Application Priority Data
Apr. 2, 2008 (EP) 08006718.4

(51) Int. Cl. H04B 17/00

(52) U.S. Cl. 375/227

(57) ABSTRACT

A method and a device enable signal-to-noise (SNR) measurement. The system includes the following steps: (i) at least one first network component transmits bursts to at least one second network component, wherein each burst comprises several sub-carriers or tones; and (ii) a third network component performs an SNR measurement for the bursts. In addition, a communication system with such a device is described.

The invention relates to a method and to a device for SNR measurement and to a communication system comprising such a device.

Existing Digital Subscriber Line (DSL) technologies (e.g., ADSL2plus, VDSL2) are limited in terms of data rate and reach. Limiting factors are in particular crosstalk and noise induced on the line.

An alternative transmission method is used with DSL systems that relies on a non-stationary transmission of data. An example for such non-stationary transmission is a burst transmission comprising idle times between said bursts. Such a transmission is non-stationary in a sense that the transmission itself is not continuous, instead it comprises bursts of transmission and time periods of no transmission between such bursts.

In ADSL2 and ADSL2plus a so-called “L2 mode” is known as a power-saving mechanism. A line which operates in L2 mode, transmits data with reduced power. However, the L2 mode bears particular disadvantages, e.g., it increases a susceptibility of neighboring lines to crosstalk. When a first line switches to L2 mode, it generates less crosstalk on neighboring second lines. As a consequence, neighboring second lines may adapt their transmission parameters to this reduced crosstalk. When the first line switches back from L2 mode into full power transmission mode, neighboring second lines experience an increased crosstalk caused by the first line and thus need to adapt their transmission parameters. Such adaptation requires some time and, in many cases, cannot be performed fast enough to compensate the increased crosstalk. Hence, such sudden increase of crosstalk caused by the first line results in severe degradation of a transmission quality on said second lines. In some cases, the second lines may even need retraining. Thus, said L2 mode is widely unused.

However, there is an ongoing discussion as how to save energy when transmitting data over the fixed line, in particular to avoid high power consumption especially when a minor amount of data traffic is conveyed over a digital subscriber line.

The problem to be solved is to overcome the disadvantages stated above and in particular to provide an efficient approach that enables a reduced power consumption.

This problem is solved according to the features of the independent claims. Further embodiments result from the depending claims.

In order to overcome this problem, a method for SNR measurement is provided comprising the steps:
at least one first network component transmits bursts to at least one second network component, wherein each said burst comprises several sub-carriers or tones;
a third network component performs an SNR measurement for said bursts.

The third network component is not directly fed by the bursts issued by the first network component. The at least one second network component as well as the third network component (there may in particular even be more than one such third network component) may be connected to the first network component. As an alternative, the at least one second network component and the third network component can be connected to different first network components, in particular different DSLAMs, wherein the lines are part of the same cable binder.

Hence, the third network component utilizes crosstalk from the burst conveyed to the at least one second network component in order to evaluate how such burst affects its line to the first network component.

Hence, this approach allows to efficiently determine a worst case crosstalk and/or interference scenario during such bursts. As the bursts result in significant (in particular maximum) crosstalk, the adjustment of the lines based on such crosstalk and/or interference results in a stable system during normal operation. In addition, burst transmission can be efficiently used over digital subscriber lines according to the solution suggested herein. This may lead to a significant reduction of transmission power, in particular during time periods of minor traffic load.

It is noted that said SNR measurement refers to any kind of measurement that determines a disturbance over a channel, line or connection.

In an embodiment, said SNR measurement is processed for at least one line between the first network component and the at least one third network component.

In another embodiment, said at least one line is a digital subscriber line (DSL), wherein the bursts are fed to the at least one second network component via at least one digital subscriber line.

In a further embodiment, the at least one first network component is or is associated with a central office (CO) or a digital subscriber line access multiplexer (DSLAM).

In a next embodiment, the at least one second network component and/or the third network component is or is associated with at least one customer premises equipment (CPE).

It is also an embodiment that the result of the SNR measurement is provided to the first network component.

Pursuant to another embodiment, the first network component adjusts a signal strength for data to be conveyed based on the SNR measurement.

According to an embodiment, the SNR measurement is corrected based on at least one additional SNR measurement value.

Hence, one SNR measurement value may be considered defective if it differs by more than a given threshold from at least one further measurement value. Such at least one further measurement value may be at least one adjacent SNR measurement value (in the time domain, at least one preceding SNR measurement value; also, in the frequency domain, at least one SNR measurement value of at least one adjacent or neighboring sub-carrier). A correction of said defective SNR value can be achieved, e.g., by means of interpolation regarding, e.g., its previous SNR measurement value(s) and/or its adjacent or neighboring SNR measurement value(s).

It is also an embodiment that said additional SNR measurement value comprises at least one chronologically adjacent and/or locally adjacent SNR measurement value. The SNR measurement may in particular be corrected based on (means of) interpolation and/or correlation.

According to another embodiment, the first network component and/or the third network component is synchronized based on a data pattern conveyed via an adjacent line.

In yet another embodiment, said data pattern is conveyed via crosstalk.

Hence, crosstalk induced during such burst periods may be effectively utilized in order to synchronize at least one network component with at least one other network component.

The problem stated above is also solved by a device comprising a and/or being associated with a processor unit and/or a hard-wired circuit and/or a logic device that is arranged such that the method as described herein is executable thereon.

According to an embodiment, the device is a communication device, in particular a DSL transmitter and/or a DSL receiver.

It is also an embodiment that said device is or is associated with a customer premises equipment and/or with a central office.

Said central office in particular relates to and/or comprises any kind of DSLAM and/or line card functionality.

The problem stated supra is further solved by a communication system comprising the device as described herein.

Embodiments of the invention are shown and illustrated in the following figures:

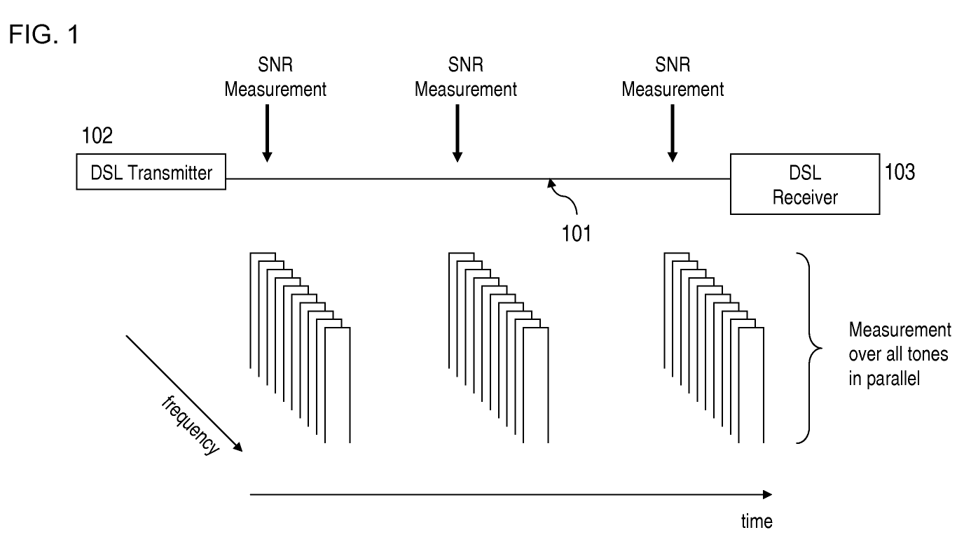

FIG. 1 shows a communication channel between a DSL transmitter and a DSL receiver, wherein at a given rate bursts are conveyed from the DSL transmitter to the DSL receiver;

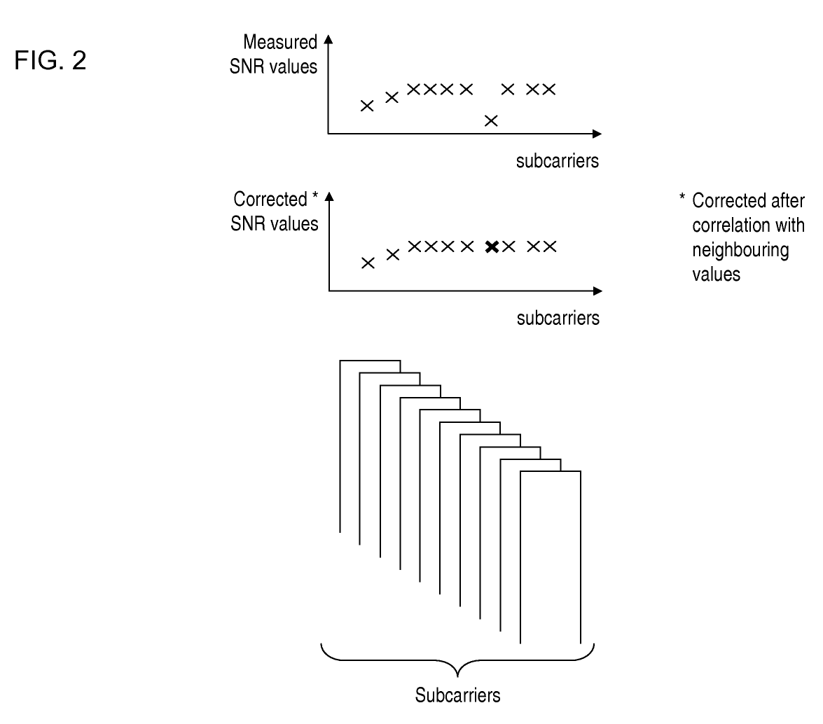

FIG. 2 shows measured SNR values for a number of subcarriers, which are corrected based on a chronological context or based on a local context.

A transmitter conveys a burst (referred to also as synchronination burst or “sync burst”) comprising sub-carriers or tones (in particular all frequency bands) to be used for communication purposes. Such burst is transmitted at a substantially constant time interval, e.g., every T seconds.

The duration between the bursts can be utilized for transmitting further bursts and/or other non-stationary signals. In particular, such signals may comprise no signal at all (e.g., silence on the line).

Receivers of lines adjacent to the line that conveys the actual burst may measure a signal-to-noise ratio (SNR) on several or in particular on all sub-carriers during each such burst. Hence, the receivers become aware of the crosstalk to their respective own line induced by a burst conveyed over a different line.

Each receiver may further improve an accuracy of the SNR measurements by evaluating a correlation between measured SNR values of sub-carriers and measured values of adjacent or neighboring sub-carriers (or tones) in order to determine, e.g., a mean value. This may significantly reduce a variance in evaluating said SNR and hence allow the measurements to become more accurate.

One particular advantage of the concept provided is that the SNR measurement may be determined for all used sub-carriers during the same measurement step. Hence, frequency-domain interpolation between measured SNR values is not required at the receiver. Hence, processing of measured SNR values requires less computational effort.

Advantageously, this concept can be well combined with a non-stationary transmission concept, utilizing particular bursts.

A further advantage of this approach is that it allows utilizing non-stationary transmission modes to operate in frequency bands already occupied by legacy DSL systems. The approach may be introduced into existing DSL systems by firmware modifications only and thus it can be applied to existing installations or deployments.

FIG. 1 shows a communication channel 101 between a DSL transmitter 102 and a DSL receiver 103. Such channel 101 (or DSL line) is disturbed via crosstalk induced from at least one other line (not shown). This at least one other line conveys bursts that interfere with the channel 101.

The same may apply in an analogue manner to the channel 101 conveying bursts from the DSL transmitter to the DSL receiver 103, wherein said bursts may cause crosstalk to at least one other line (not shown).

At a given rate (i.e. separated from one another by a time period T), crosstalk bursts of another line affect the channel 101 and can be utilized for SNR measurement purposes.

As a burst may comprise several tones or (sub-)carriers in parallel, the DSL receiver 103 is enabled to process the SNR measurement for a worst-case crosstalk situation.

The DSL receiver 103 may then report to the DSL transmitter 102 its SNR measurement values and the DSL transmitter 102 may thereupon adjust its transmission power.

Advantageously, such scenario can be efficiently used for burst transmission purposes. During the burst transmission, the worst-case crosstalk is known and the adaptation of the line according to SNR measurement values as determined allows to cope with the physical interference and crosstalk characteristics of the line(s).

It is noted that DSL refers to all present and upcoming technologies utilizing any kind of digital subscriber line technology, e.g., ADSL, VDSL, etc.

FIG. 2 shows measured SNR values for a number of sub-carriers. If, e.g., an SNR measurement value for one sub-carrier is significantly lower (or higher) than SNR measurement values for at least one adjacent sub-carrier, such SNR measurement value may be corrected by means of correlation and/or interpotation. However, there are several possibilities to determine whether at least one SNR measurement value is considered to be wrong and also several possibilities as how to correct such wrong value(s).

For example, a wrong SNR measurement value may be determined by exceeding a predetermined threshold for a difference between at least one adjacent and/or at least one previous SNR measurement value. It is in particular possible to not consider neighboring values, but only previous SNR measurement values for this particular sub-carrier.

If such SNR measurement value is considered wrong and needs to be adjusted, this can be done by means of interpolation regarding this particular value's previous at least one SNR measurement value and/or at least one of the adjacent SNR measurement values (regarding a chronological context and/or a local context).

Synchronization:

Various transmitters that are deployed or associated with different central offices (COs) or shelters or DSLAMs (within the same CO or between various COs) or line cards within a particular DSLAM may have to be synchronized with one another in order to ensure that bursts are transmitted at substantially the same time.

The synchronization could be provided for the receivers listening to crosstalk caused by said bursts on adjacent lines. The bursts may comprise a particular data pattern to be recognized via crosstalk and used for synchronization purposes by an adjacent line.

Hence, receivers within the CO (or a cabinet, a DSLAM or a line card, etc.) may listen for crosstalk in downstream frequency bands. Accordingly, receivers deployed with the customer premises equipment (CPE) may listen to crosstalk in downstream frequency bands and convey the synchronization information received (back) to the transmitter (that may, e.g., be located in the CO). Hence, CPEs can be synchronized by the CO via synchronized downstream transmission.

The synchronization concept described is applicable to upstream transmission accordingly.

The proposed synchronization concept does not need external equipment or additional software to be run with the CO. It may just require an upgrade for the DSL transceivers. Such modification may be provided together with an implementation of the new mode of transmission. Hence, such enhancement of the physical layer may only require modifications of such physical layer, but it does not require any further changes to upper layers, in particular to portions of the system outside the DSL transmission (i.e., the line together with DSL transceivers at both ends).

Abbreviations:

ADSL Asymmetric Digital Subscriber Line

CO Central Office

CPE Customer Premises Equipment

DMT Discrete Multi Tone

DSL Digital Subscriber Line

DSLAM DSL Access Multiplexer

SNR Signal to Noise Ratio

VDSL2 Very high speed Digital Subscriber Line 2

1-16. (canceled)

17. A method for measuring a signal-to-noise ratio (SNR), the method which comprises the following steps:
transmitting from at least one first network component bursts to at least one second network component, each of the bursts including a plurality of sub-carriers or tones; and
measuring a signal-to-noise ratio (SNR) for the bursts in an SNR measurement with a third network component.

18. The method according to claim 17, wherein the SNR measurement is processed for at least one line connecting the first network component and the third network component.

19. The method according to claim 18, wherein the at least one line is a digital subscriber line and/or wherein the bursts are fed to the at least one second network component via at least one digital subscriber line.

20. The method according to claim 17, wherein the at least one first network component is a central office or a digital subscriber line access multiplexer.

21. The method according to claim 17, wherein the at least one first network component is associated with a central office or with a digital subscriber line access multiplexer.

22. The method according to claim 17, wherein one or both of the at least one second network component and the third network component is/are at least one customer premises equipment.

23. The method according to claim 17, wherein one or both of the at least one second network component and the third network component is/are associated with at least one customer premises equipment.

24. The method according to claim 17, which comprises providing a result of the SNR measurement to the first network component.

25. The method according to claim 24, which comprises adjusting with the first network component a signal strength for data to be conveyed based on the SNR measurement.

26. The method according to claim 17, which comprises correcting the SNR measurement based on at least one additional SNR measurement value.

27. The method according to claim 26, wherein said additional SNR measurement value comprises at least one chronologically adjacent and/or locally adjacent SNR measurement value.

28. The method according to claim 26, which comprises correcting the SNR measurement based on at least one of interpolation and correlation.

29. The method according to claim 17, which comprises synchronizing one or both of the first network component and the third network component based on a data pattern conveyed via an adjacent line.

30. The method according to claim 29, wherein said data pattern is conveyed via crosstalk.

31. A device configured to perform the method of claim 17, the device comprising: a processing unit programmed to carry out the method according to claim 17, the processing unit being at least one of a processor unit in the device, a processor unit associated with the device, a hardwired circuit, or a logic device.

32. The device according to claim 31, formed as a communication device.

33. The device according to claim 32, configured as a DSL transmitter.

34. The device according to claim 32, configured as a DSL receiver.

35. The device according to claim 31, configured in at least one of a customer premises equipment and a central office.

36. The device according to claim 31, wherein said device is associated with at least one of a customer premises equipment and a central office.

37. A communication system, comprising the device according to claim 31.
